(19) United States
(12) Patent Application Publication
(10) Pub. No.: US 2007/0189804 A1
(43) Pub. Date: Aug. 16, 2007

(54) Image forming apparatus

(76) Inventor: Takuya Yasumitsu, Tokyo (JP)

Correspondence Address: Eugene LeDonne;Reed Smith LLP, 599 Lexington Avenue, New York, NY, 10022-7650, US

(21) Appl. No.: 11/593,861

(22) Filed: Nov. 7, 2006

(30) Foreign Application Priority Data
Nov. 7, 2005 (JP) 2005-322731
Nov. 1, 2006 (JP) 2006-297911

(51) Int. Cl. G03G 21/18; G03G 15/04; G03G 15/16

(52) U.S. Cl. 399/111; 399/119; 399/121

(57) ABSTRACT

Since a releasing unit for performing a separating operation of a transfer unit and a developing device from a drum unit and a releasing operation of an engagement state held by a holding unit as one operation is provided, the drum unit can be put in a drawable state at a drawing-out time of the drum unit from an apparatus main unit by performing one operation through the releasing unit, and since the releasing unit is constituted so as to cover a drawing-out unit provided on an image bearing member unit at a mounting time of image bearing member unit and release the drawing-out unit at a drawing-out time of the image bearing member unit, a user's erroneous operation can be prevented reliably, where improvement in safety can be achieved by preventing an erroneous operation while facilitating the drawing-out operation of the drum unit.

### FIELD OF THE INVENTION

The present invention relates to an image forming apparatus such as a copier, a printer, or a facsimile machine, and in particular to an image forming apparatus configured such that a unit including an image bearing member (a photosensitive member) for image formation can be drawn.

### BACKGROUND OF THE INVENTION

In an image forming apparatus adopting an electrophotographic technology or the like, generally, a surface of a photosensitive drum 100 which is one example of an image bearing member is evenly charged by a charging unit 101, an electrostatic latent image is formed on the surface of the photosensitive drum 100 by irradiating scanning light 102 on the surface from an optical unit 11, and a toner image is formed by transferring toner on the electrostatic latent image by a developing device 5 like a copier (a copying machine) shown in FIG. 1, FIG. 2, and FIG. 3. After the toner image formed on the photosensitive drum 100 is transferred to a recording member such as a paper by a transfer roller 104, and the toner image is heated and pressurized in the fixing unit 105 so that it is fused or fixed on the recording member.

The transfer roller 104, registration rollers 106, and the like which are disposed to face the photosensitive drum 100 are integrally constituted as a transfer unit 3, and conveying paths defined between the registration rollers 106 and between the photosensitive drum 100 and the transfer roller 104 can be opened, for example, by pivoting the transfer unit 3 about a vertical rotating supporting shaft extending in a vertical direction (an apparatus height direction) outwardly from an apparatus main unit 2 in a door-opening manner so that jam handling or the like can be conducted easily.

The above-described developing device 5 includes a developing sleeve 108, a toner container 109, a toner stirring unit 103, and the like disposed integrally. A toner bottle 111 is constituted integrally with the developing device 5 or separately therefrom. The developing sleeve 108 is caused to abut on the photosensitive drum 100 via rolls disposed at both ends of the developing sleeve 108 in an axial direction thereof, and it is maintained in a state that it is spaced from the photosensitive drum 100 by a predetermined distance.

At this case, the above-described photosensitive drum (the image bearing member) 100, a cleaner container 110, the charging unit 101, and other members are configured integrally as a drum unit (an image bearing member unit) 1, and drum unit 1 can be drawn to the apparatus main unit 2 forwardly (in a near side direction on the drawing) so that replacement of a part whose life has expired with a new part, maintenance, or the like can be performed easily, for example, as disclosed in Patent literature 1 (JP-A-07-281581) and Patent Literature 2 (JP-A-08-254862). Such a drum unit 1 constituted so as to be drawn from the apparatus main unit 2 is supported to the apparatus main unit 2 by a holding unit in a vertical direction, in left and right directions, and in a drawing-out direction.

On the other hand, in such a image forming apparatus such as a laser printer, for example, the above-described drum unit 1 and transfer unit 3 are put in a relationship of engagement with each other. That is, the photosensitive drum 100 and the transfer roller 104 are disposed in a state that they abut on each other through their outer peripheral faces (or approach to each other), and they are coupled to each other through a gear (not shown). Accordingly, when drum unit 1 such as described above is drawn from the apparatus main unit 2, damage to the surfaces of the photosensitive drum 100 and the transfer roller 104, and the gear portion must be avoided by releasing the relationship of engagement of the drum unit 1 with the transfer unit 3 prior to the drawing-out of the drum unit 1.

That is, for drawing out the drum unit 1 from the apparatus main unit 2, a plurality of releasing operations of an operation for spacing the transfer unit 3 including the transfer roller 104 from the drum unit 1, for example, by pushing a button A shown in FIG. 2, an operation for releasing an engagement state in a direction of drawing-out of the drum unit 1, for example, by detaching a screw B shown in FIG. 2, an operation for separating the rolls at the both ends of the developing sleeve 108 in the developing device 5 put in an abutting relationship on the photosensitive drum 100, for example, by performing an releasing operation of a lever C shown in FIG. 2, and the like must be sequentially performed, where at least three releasing operations (actions) must be performed.

In addition, the conventional image forming apparatus does not include a unit or means for making a user to conduct such releasing operations required at a drawing-out time of such a drum unit 1 reliably so that an unexpected accident may occur due to an erroneous operation performed by the user.

On the other hand, releasing coupling for transmitting driving force from a driving source in the apparatus main unit 2 to the photosensitive drum 100 is problematic at the drawing-out time of the drum unit 1 as described above. That is, in such an image forming apparatus as described above, for example, coupling such as shown in FIG. 11 is performed in a driving force transmission route between the apparatus main unit 2 and the drum unit 1 for transmitting driving force from the apparatus main unit 2 to the drum unit 1. When the drum unit 1 is taken out of the apparatus main unit 2 at a time of replacement of the drum unit 1 or at a jam handling time, the coupling must be released, but it is necessary to rotate the driving unit in a reverse direction to a rotating direction during image forming operation in order to release a coupling portion.

In one example of a specific constitution of the coupling portion and a coupling-releasing method, as shown in FIG. 11, a twisted triangular protrusion 151a is provided on a rotating shaft on the side of the photosensitive drum 100 and a twisted triangular recess 152b is provided on a rotating shaft 152a of a photosensitive drum drive gear on the apparatus main unit so as to be fitted on the projection 151a. It is necessary to force the protrusion 151a on the side of the photosensitive drum into the recess 152b of the photosensitive drum drive gear on the side of the main unit in order to cause these members to mesh with each other. Thereby, since the two meshing portions attract each other, meshing with reduced chattering can be realized.

It is necessary to rotate the drive unit in a reverse direction to the meshing direction in order to release such a coupling portion. In the conventional art, for example, a rotating cam 171 and a fixed cam 172 which are linked to an opening and closing door (not shown) are provided between a photosensitive drum drive gear 152 and a photosensitive drum drive gear supporting member 153, as shown in FIG. 19, and the rotating cam 171 is rotated through the link to move a face of the fixed cam 172 in an axial direction and move the photosensitive drum drive gear 152 by opening the opening and closing door, as shown in FIG. 20. At this time, the photosensitive drum drive gear 152 performs releasing of the coupling portion while it is being rotated in a reverse direction during movement thereof, in view of the structure of the meshing portions. Thus, the drive unit is generally rotated in the reverse direction by a force for opening the opening and closing door so that releasing of the coupling in the drive path is performed. As such a releasing method of the coupling portion, various methods such as disclosed in Patent Literature 3 (JP-A-10-142996), Patent Literature 4 (JP-A-08-268594), and the like have been proposed.

However, when the drive unit is rotated in a reverse direction to release the coupling portion as described above, a force larger than a stopping load of the drive unit must be applied to the drive unit, and since the force for rotating the drive unit in the reverse direction is not applied to the drive unit directly but the drive unit is rotated in the reverse direction indirectly via the structure of the meshing portions, a large operation force is required due to increase of a load, which results in lowering of usability such as giving a user cause for anxiety.

In view of these circumstances, an object of the present invention is to provide an image forming apparatus which enables a user to perform an operation for drawing a drum unit from an apparatus main unit easily and safely.

### SUMMARY OF THE INVENTION

In order to achieve the object, there is provided an image forming apparatus comprising: an image bearing member unit which includes an image bearing member for image formation and can be drawn from an apparatus main unit; a transfer unit which includes a transfer roller for transferring an image formed on the image bearing member to a recording member and is disposed to be capable of separating from the image bearing member unit; a developing device which including a developing sleeve for supplying toner on the image bearing member and is disposed to be capable of separating from the image bearing member unit; and a holding unit which is constituted so as to be capable of holding the image bearing member unit to the apparatus main unit and releasing the image bearing member unit from the apparatus main unit, wherein the image forming apparatus further comprises a releasing unit which performs a separating operation for separating the transfer unit and the developing device from the image bearing member unit and a releasing operation of the image bearing member unit performed by the holding unit as a single operation when the image bearing member unit is drawn out from the apparatus main unit, and the releasing unit is constituted to cover a drawing-out unit provided on the image bearing member unit at a mounting time of the image bearing member unit and to open the drawing-out unit at a drawing-out time of the image bearing member unit.

For example, the releasing unit is link-connected so as to rotate the developing unit and the holding unit in synchronism with rotation of the releasing unit and the holding unit is link-connected so as to release the transfer unit in synchronism with rotation of the holding unit.

According to the image forming apparatus thus constituted, when the image bearing member unit is drawn from the apparatus main unit, the image bearing member unit can be put in a drawable state by performing only one operation to the releasing unit, the drawing-out operation of the image bearing member unit is facilitated and erroneous operation performed by a user is prevented so that safety is improved. At this time, a user's erroneous operation to the releasing unit is prevented reliably.

The releasing unit is constituted so as to disconnect a drive transmission path from the apparatus main unit to the image bearing member unit when the image bearing member unit is drawn out from the apparatus main unit.

According to the image forming apparatus thus constituted, since the drive transmission path to the image bearing member unit is disconnected by performing only one operation to the releasing unit when the image bearing member unit is drawn from the apparatus main unit, facilitation and safety in the drawing-out operation of the image bearing member unit are further improved.

As described above, since the image forming apparatus according to the present invention includes the releasing unit which performs the operation for separating the transfer unit and the developing device from the image bearing member unit and the operation for releasing the holding state of the image bearing member unit maintained by the holding unit by performing a single operation when the image bearing member unit is drawn from the apparatus main unit, the image bearing member unit is put in a drawable state by performing a single operation to the releasing unit, and since such a constitution is adopted that the drawing-out unit provided on the image bearing member unit is covered by the releasing unit at a mounting time of the image bearing member unit and it is opened at a drawing-out time of the image bearing member unit, a user's erroneous operation to the releasing unit can be prevented reliably, so that improvement of safety can be achieved by preventing an erroneous operation while the drawing-out operation of the image bearing member unit is facilitated, and both reliability and utility of the image forming apparatus can be improved.

### BRIEF DESCRIPTION OF THE DRAWINGS

FIG. 1 is a vertical sectional explanatory view showing one example of a structure of a copier which is an image forming apparatus to which the present invention is applied;

FIG. 2 is an appearance perspective explanatory view of a conventional copier;

FIG. 3 is an appearance perspective explanatory view showing a state that a transfer unit portion of the copier shown in FIG. 1 has been opened;

FIG. 4 is an interior perspective view showing a state that a drum unit has been mounted in an embodiment of the present invention;

FIG. 5 is an appearance perspective explanatory view showing an appearance structure of the drum unit in the embodiment of the present invention;

FIG. 6 is a front explanatory view showing a schematic structure about the drum unit in a state that a developing device has been put in a pressurized state in the embodiment of the present invention;

FIG. 7 is a front explanatory view showing a schematic structure about the drum unit in a state that a pressurizing state of the developing device has been cancelled in the embodiment of the present invention;

FIG. 8 is an interior perspective explanatory view showing a state that the drum unit has been mounted in the embodiment of the present invention;

FIG. 9 is a front sectional view of a portion about the drum unit in a state that a releasing lever, a holding unit, the transfer unit and the developing device have been released in the embodiment of the present invention;

FIG. 10 is a front explanatory view showing a photosensitive drum drive route and a mechanism thereof in the embodiment of the present invention in an enlarging manner;

FIG. 11 is an appearance perspective explanatory view showing one example of a coupling mechanism in the photosensitive drum drive route;

FIG. 12 is an appearance perspective explanatory view showing one example of a connecting and disconnecting mechanism of the coupling mechanism in the photosensitive drum drive route;

FIG. 13 is a front explanatory view showing a state that the photosensitive drum drive route has been released in the embodiment of the present invention;

FIG. 14 is a side explanatory view showing a gear meshing state in the photosensitive drum drive route in the embodiment of the present invention;

FIG. 15 show switched states of the coupling mechanism in the photosensitive drum drive routes, FIG. 15(a) including an appearance perspective explanatory view and a side explanatory view showing a connected state of the coupling mechanism and FIG. 15(b) including an appearance perspective explanatory view and a side explanatory view showing a released state of the coupling mechanism;

FIG. 16 is a vertical sectional explanatory view showing a reduction gear disposed in the photosensitive drum drive route in the embodiment of the present invention in an enlarging manner;

FIG. 17 is an appearance perspective explanatory view showing a connected state of the coupling mechanism in the photosensitive drum drive route;

FIG. 18 is an appearance perspective explanatory view showing a released state of the coupling mechanism in the photosensitive drum drive route;

FIG. 19 is a front explanatory view showing a conventional photosensitive drum drive route and a mechanism thereof in an enlarging manner; and

FIG. 20 is a front explanatory view showing another conventional photosensitive drum drive route and a mechanism thereof in an enlarging manner.

### BEST MODE FOR CARRYING OUT THE INVENTION

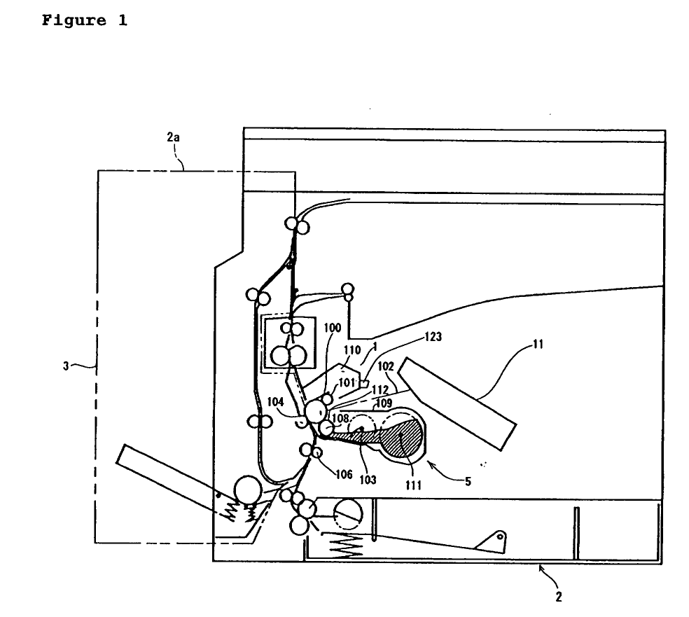

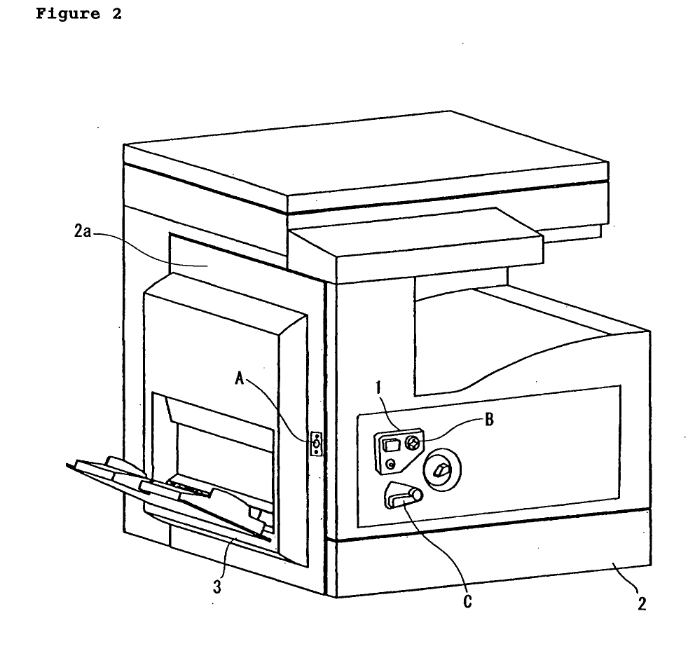

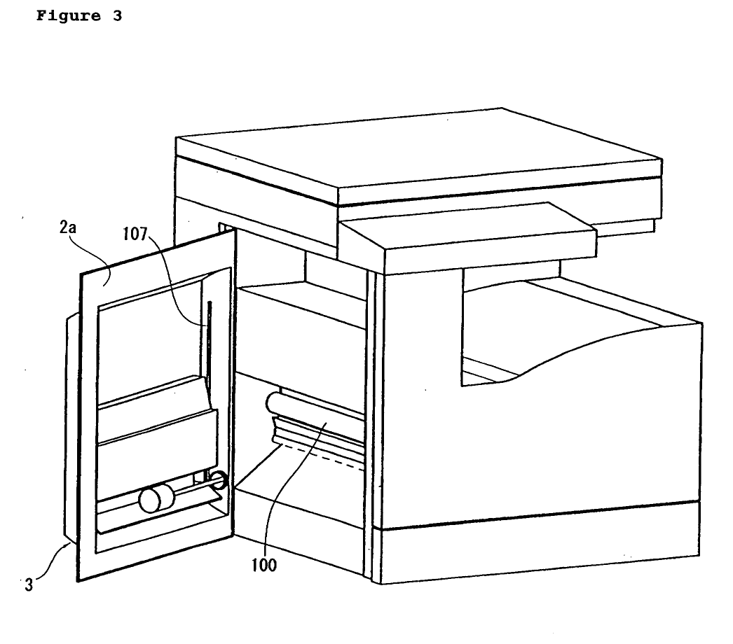

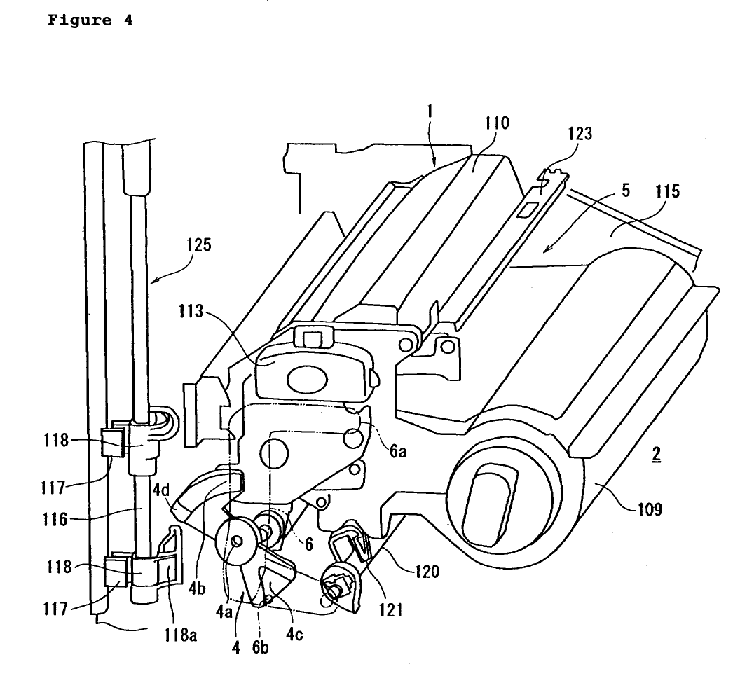

An embodiment of a constitution adopted when the present invention is applied to a copier which is an image forming apparatus shown in FIG. 1 and FIG. 3 described above will be explained in detail together with attaching and detaching operations of a drum unit 1 with reference to FIG. 4 to FIG. 9.

First, a guide rail 123 which supports a drum unit 1 such that the drum unit 1 serving as an image bearing member unit can be inserted toward a depth direction (a longitudinal direction) from a front of a copier and drawn from the copier when the copier is used is provided so as to extend along a longitudinal direction within an apparatus main unit 2. A handle 113 serving as a drawing-out unit for user's drawing-out operation is provided on the near side of the drum unit 1 so as to project to the near side.

When such a drum unit 1 is attached to or detached from the apparatus main unit 2, the drum unit 1 is inserted in the depth direction (the longitudinal direction) from a front side of the apparatus main unit 2 or drawn in a direction reverse thereto along the guide rail 123, where a user gasps the handle 113 to push the drum unit 1 to the depth side or draw the same to the near side for insertion or drawing of such a drum unit 1.

On the other hand, positioning holes 124a, 124b and a positioning boss 124c (see FIG. 5, especially) are provided on both faces of the cleaner container 110 in its longitudinal direction for holding the drum unit 1 in a horizontal direction (a short direction) perpendicular to the above-described depth direction (in the longitudinal direction), and these holes and the boss are engaged with both front and rear walls 114, 115 (see FIG. 8, especially) of the apparatus main unit 2. That is, when the drum unit 1 is mounted in the apparatus main unit 2, a depth side of the drum unit 1 is caused to abut on the rear wall 115 of the apparatus main unit 2 and a near side of the drum unit 1 is engaged with a holding unit 4 (see FIG. 4, especially) provided on the apparatus main unit 2.

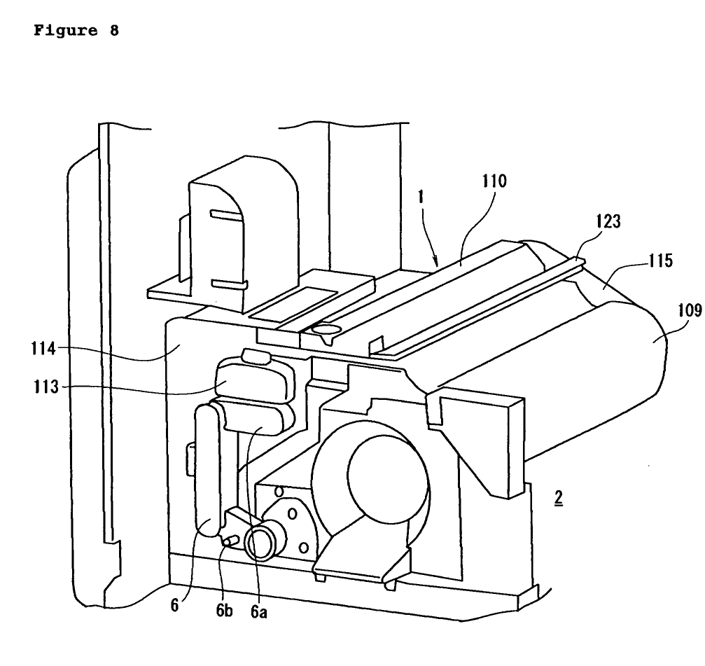

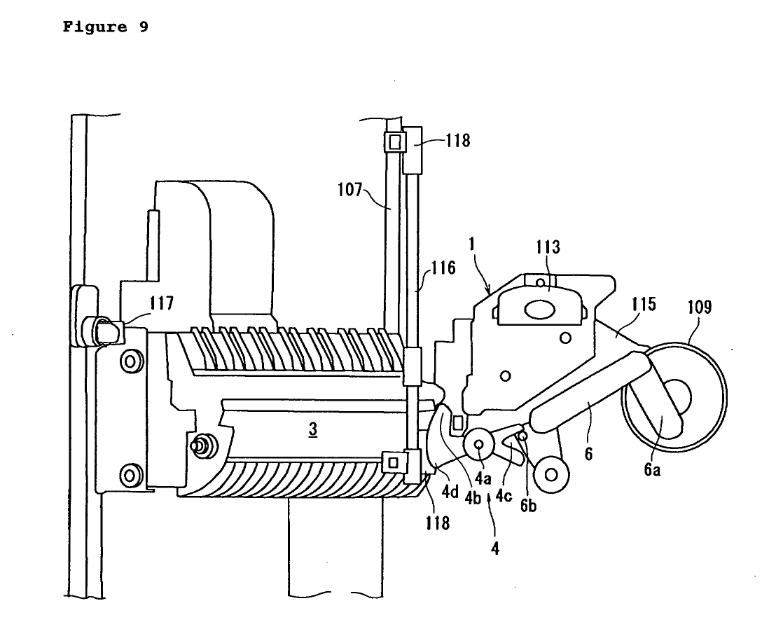

The holding unit 4 in the embodiment is disposed near an inside of the front wall 114 of the apparatus main unit 2 and it is attached so as to be rotatable about a rotating shaft 4a extending along the depth direction. When the drum unit 1 has been mounted to the apparatus main unit 2, since an engagement plate 4b of the holding unit 4 formed in a fan shape is disposed to be rotated up to a standing position to face a near side of the drum unit 1, as shown in FIG. 4, so that drawing-out of the drum unit 1 is made impossible. On the other hand, when the engagement plate 4b is rotated to an approximately horizontal position, as shown in FIG. 9, the engagement plate 4b is deviated from the near side of the drum unit 1 so that drawing-out of the drum unit 1 is made possible.

The transfer unit 3 which integrally has the transfer roller 104, the registration roller 106, and the like is fixed to an inner face of an opening and closing door portion 2a disposed on a side face of the apparatus main unit 2. The opening and closing door portion 2a is mounted on a depth or far side of the apparatus main unit 2 so as to be rotatable about a vertical rotation supporting shaft 107 disposed so as to extend in a vertical direction (an apparatus height direction), and the transfer unit 3 is rotated in a door-opening manner to the outside of the apparatus main unit 2 to be opened according to an opening operation of the opening and closing door portion 2a. Hooks 117 are provided on a rotating side end edge portion of the opening and closing portion 2a fixed with the transfer unit 3, and when the opening and closing door portion 2a is closed, the hooks 117 are engaged with hook receivers 118 of a rotating shaft unit 125 provided on the front wall 114 of the apparatus main unit 2, so that the opening and closing door portion 2a is locked in a closed state and the transfer unit 3 is held at an image forming position.

On the other hand, portions of the hook receivers 118 are pressed by a releasing lever 6 described later, so that the hooks 117 are released from the hook receivers 118, and the opening and closing door portion 2a fixed with the transfer unit 3 is rotated about the vertical rotation supporting shaft 107 in an opening direction by a biasing unit such as a spring (not shown) to get away from the drum unit 1.

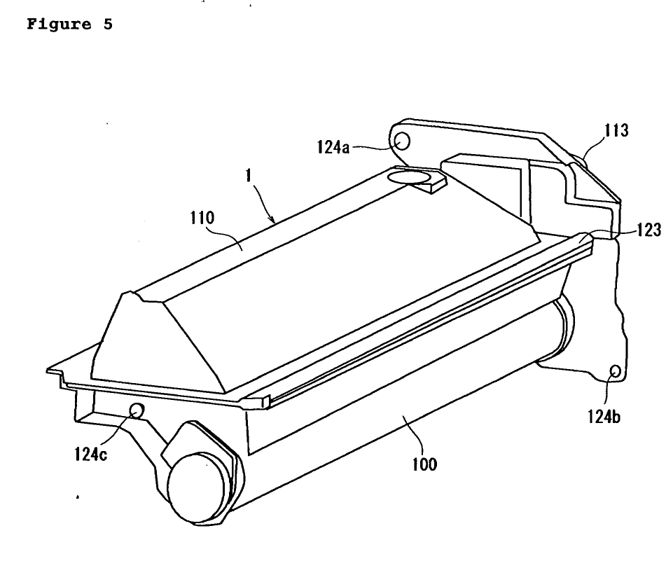

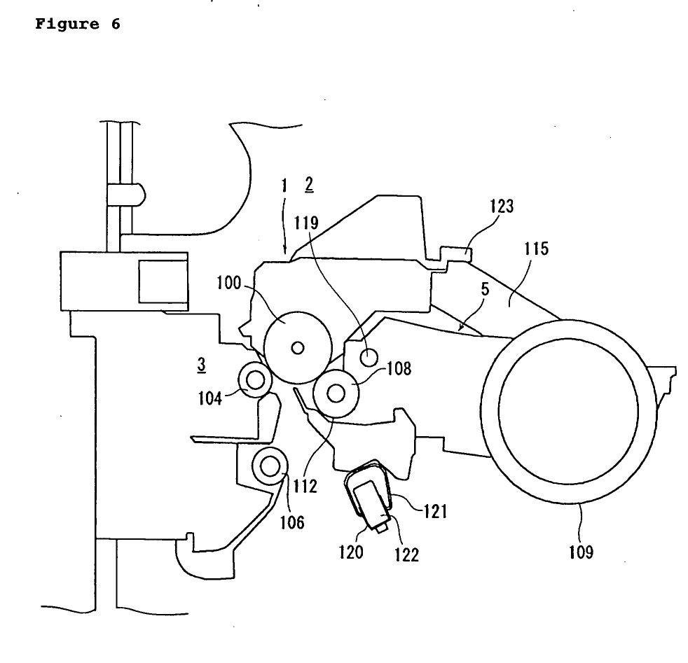

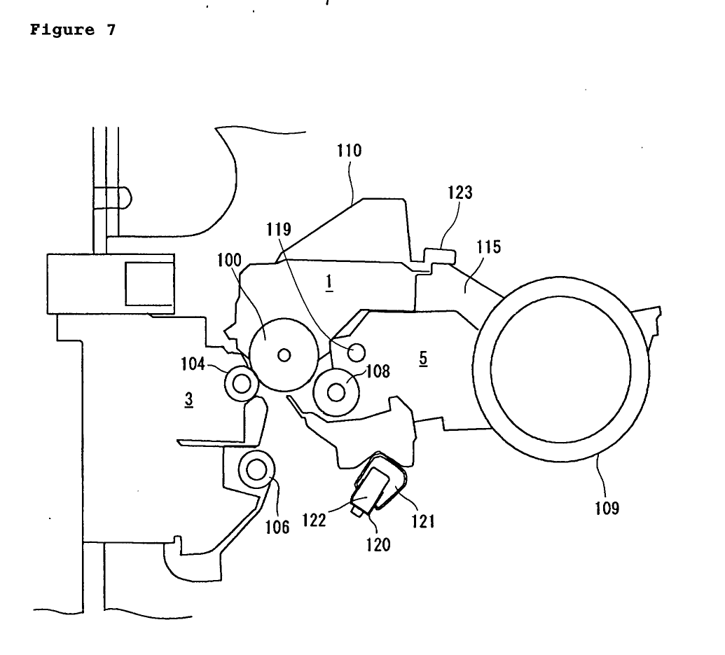

In the developing device 5, rotation supporting points 119 are respectively provided at both end faces of a toner container 109 in a widthwise direction thereof (in the longitudinal direction), and the rotation supporting points 119 are rotatably fitted so as to constitute a relationship between bosses and holes at positions facing the front and rear walls 114 and 115 of the apparatus main unit 2. When the developing device 5 is rotated about both the rotation supporting points 119 as a whole, the developing sleeve 108 is moved between a state that it approaches to an outer peripheral face of the photosensitive drum 100 (see FIG. 6) and a state that it is spaced therefrom (see FIG. 7). At this time, rolls 112 are disposed at both end portions of the developing sleeve 108 in an axial direction thereof (the depth direction), respectively, and the rolls 112 are caused to rotatably abut on an outer peripheral surface of the photosensitive drum 100 in a state that the developing sleeve 108 has approached to the photosensitive drum 100 (see FIG. 6), so that the developing sleeve 108 is kept in a state that it is spaced from the outer peripheral surface of the photosensitive drum 100 by a predetermined distance.

A developing pressurizing shaft 120 constituting a separating mechanism for the developing device 5 is disposed at a position separated downwardly from the rotation supporting point 119 of the developing apparatus 5 so as to extend approximately in parallel with the axial direction of the developing sleeve 108 (in the longitudinal direction). That is, at least one developing and pressuring cam 121 including such a biasing unit as a spring 122 is attached to each of both end portions of the developing and pressurizing shaft 120 in the axial direction, and the developing and pressurizing cam 121 is rotated according to rotation operation of the releasing lever 6 attached to the near end portion of the developing pressurizing shaft 120, so that the developing sleeve 108 (rolls 112) is pressurized to the surface of the photosensitive drum 100 through the toner container 109 of the developing device 5, as shown in FIG. 6, or separated therefrom through the toner container 109, as shown in FIG. 7.

On the other hand, as shown in FIG. 8 and FIG. 9, the releasing lever 6 is disposed at the near side of the front wall 114 of the above-described apparatus main unit 2. The releasing lever 6 is rotated at the drawing-out time of the drum unit 1 for releasing operation, it is attached to the near side end portion of the developing and pressurizing shaft 120, as described above, and the developing and pressurizing shaft 120 constituting the separating mechanism of the above-described developing device 5 in synchronism with an rotation operation of the releasing lever 6 by an angle (for example, 60 degrees) corresponding to the rotation operation. The developing and pressurizing cam 121 is rotated according a rotation operation of the releasing lever 6 in a releasing direction so that the developing device 5 is rotated about the rotating shaft (rotation supporting points) 119 of the toner container 109 in a direction of separating from the photosensitive drum 100.

The releasing lever 6 extends upwardly in an approximately L shape from the developing and pressurizing shaft 120 serving as the rotation shaft, and a lever extension portion 6a projecting so as to bend at an approximately right angle from a distal end position thereof on an extension side thereof is put in an arrangement relationship that it conceals a hand grip portion of the handle 113 of the drum unit 1 from below during mounting of the above-described drum unit 1. Though a user's hand operation of the handle 113 can not be generally conducted owing to presence of the lever extension portion 6a, when the releasing lever 6 is rotated in the releasing direction, as described above, the hand grip portion of the handle 113 of the drum unit 1 is released so that a user's hand operation is made possible.

The releasing lever 6 is link-connected to the holding unit 4 including the engagement plate 4b engaging the above-described drum unit 1 in the longitudinal direction (in the depth direction). That is, the fan-shaped engagement plate 4b provided on the holding unit 4 is disposed at a standing position as shown in FIG. 4 during ordinary use, and it covers a portion of the near end face of the drum unit 1 so that the drum unit 1 is kept at the mounting position and it can not be drawn out.

A link groove 4c projecting in an approximately V-shape manner is provided at an opposite side of the engagement plate 4b in a diametrical direction, and a pin 6b provided on the above-described releasing lever 6 in a standing manner is inserted into the link groove 4c with a clearance or play, as especially shown in FIG. 9. When the releasing lever 6 is rotationally operated in the releasing direction, as shown in FIG. 9, the holding unit 4 is rotated about the rotating shaft 4a in a counterclockwise direction (shown) in synchronism with the rotation operation of the releasing lever 6, so that the engagement plate 4b is made approximately horizontal, and the engagement state of the drum unit 1 held by the engagement plate 4b is released.

A taper portion 4d is provided so as to extend along a distal end portion of the engagement plate 4b of the releasing lever 6 on the rotation side, and when the releasing lever 6 is rotationally operated in the releasing direction, an inclined face of the taper portion 4d continuously presses the hook receiver 118 holding the transfer unit 3 at the image forming position toward the near side so that a link relationship for rotating the rotation shaft 116 attached with the hook receiver 118 in a clockwise direction in plan view is constituted. When the rotation shaft 116 is rotated in the clockwise direction in plan view in synchronism with rotation of the releasing lever 6 in this manner, releasing of the hook 117 provided on the transfer unit 3 is performed, so that the transfer roller 104 provided on the transfer unit 3 is separated from the drum unit 1 according to opening of the above-described opening and closing door portion 2a.

As described above, in the embodiment, when the drum unit 1 is drawn from the apparatus main unit 2, the developing device 5 and the transfer roller 104 are separated from the drum unit 1 and the engagement state of the drum unit 1 held by the holding unit 4 is released by one rotation operation (one action) to the releasing lever 6, so that the drum unit 1 is immediately put in a drawable state. Therefore, the drawing-out operation of the drum unit 1 is facilitated and a user's erroneous operation is prevented so that safety is improved.

Since a hand grip portion of the handle 113 of the drum unit 1 is covered by the lever extension portion 6a of the releasing lever 6 in as state that the drum unit 1 has been mounted or loaded so that a user can not grip the hand grip portion, the drum unit 1 can not be drawn unless the releasing lever 6 is operated. Therefore, damage or the like due to an erroneous operation can be prevented from occurring.

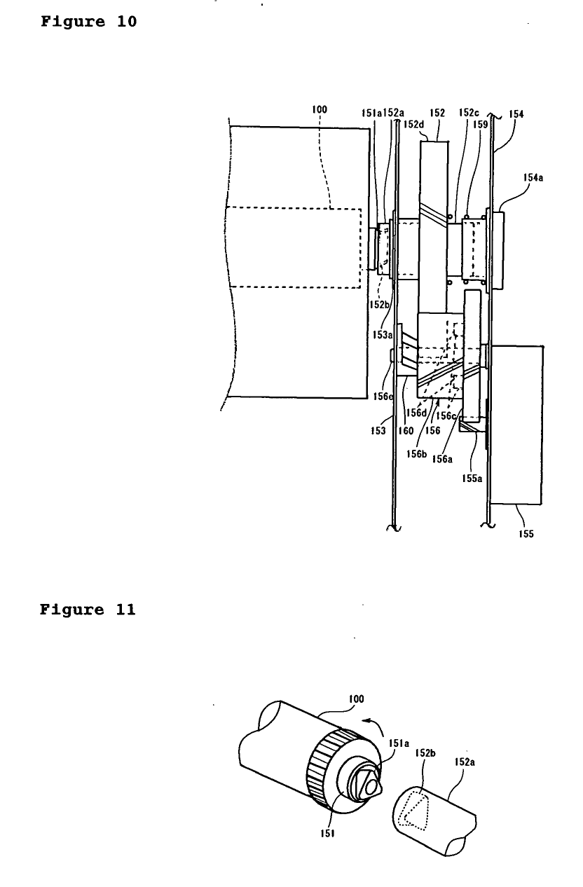

In the embodiment, the drive route from the apparatus main unit 2 to the photosensitive drum 100 is disconnected in conjunction with a separating operation by the separating mechanism of the above-described developing device 5 by one rotation operation (one action) to the above-described releasing lever 6. That is, FIG. 10 and FIG. 11 are views showing a photosensitive drum drive gear of the image forming apparatus which is the embodiment of the present invention and a plurality of gears which constitute a driving force transmitting unit in a peripheral portion thereof. In FIG. 10 and FIG. 11, a photosensitive drum drive gear 152 is arranged near an shaft end face of the rotation shaft 151 of the photosensitive drum 100 approximately concentrically with the rotation shaft 151, and a coupling projection portion 151a projecting from the shaft end face of the rotation shaft 151 of the above-described photosensitive drum 100 is formed to be engageable with a coupling recess portion 152b provided at a distal end portion of the drive shaft 152a provided with the photosensitive drum drive gear 152 in the axial direction. In the above-described photosensitive drum drive gear 152, the drive shaft 152a, a rotation center shaft portion 152c, and a gear portion 152d are integrally formed from resin.

As described above, since the coupling projection portion 151a and the coupling recess portion 152b are put in a relationship where they are caused to engage each other, centers of the photosensitive drum drive gear 152 and the photosensitive drum 100 must be caused to coincide with each other, so that a shape obtained by twisting a triangle is generally adopted for the coupling projection portion 151a and the coupling recess portion 152b such that automatic center adjustment is performed according to a forward rotation, as shown in FIG. 11. A twisting direction for the twisted shape is a direction in which a force acts such that the photosensitive drum 100 and the photosensitive drum drive gear 152 approach to each other, namely, a direction reverse to rotation direction of the photosensitive drum 100 toward a direction of a getting away from the photosensitive drum 100.

Reference numeral 153 in FIG. 10 denotes a first photosensitive drum drive gear supporting member, where the above-described rotation center shaft portion 152c is rotatably fitted in a bearing 153a provided in the first photosensitive drum drive gear supporting member 153. Reference numeral 154 in FIG. 10 denotes a second photosensitive drum drive gear supporting member, where the drive shaft 152a is rotatably fitted in a bearing 154a provided in the second photosensitive drum drive gear supporting member 154.

A motor 155 which is a drive source is fixed on an outer face of the second photosensitive drum drive gear supporting member 154, and an input gear 156a of a reduction gear 156 meshes with a pinion 155a provided on an output shaft of the motor 155. The output gear 156b of the reduction gear 156 is rotatably supported in a meshing state with the gear portion 152d of the above-described photosensitive drum drive gear 152 so that it transmits rotational drive according to rotation of the motor 155.

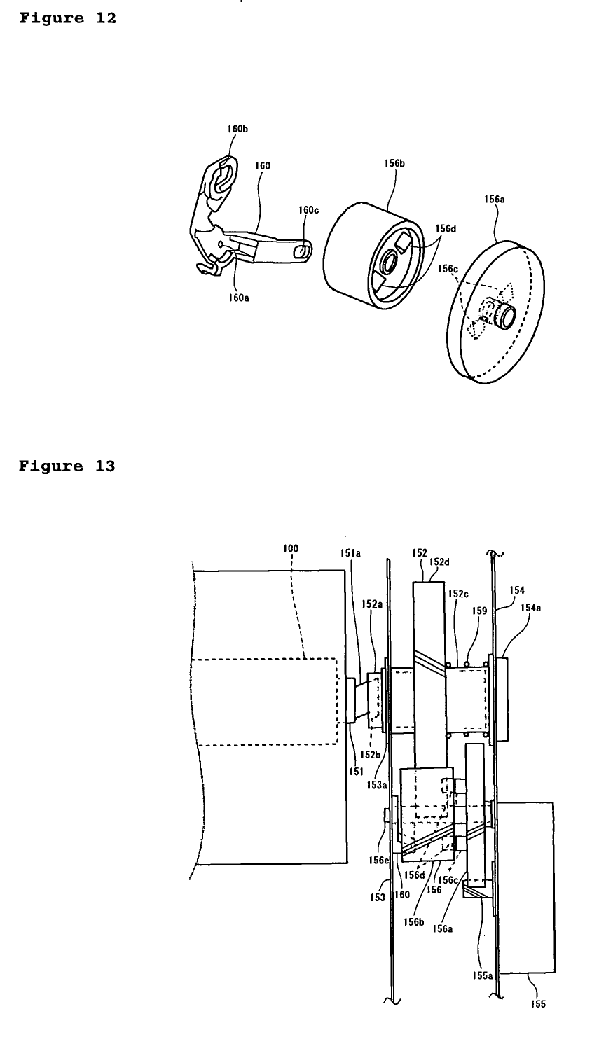

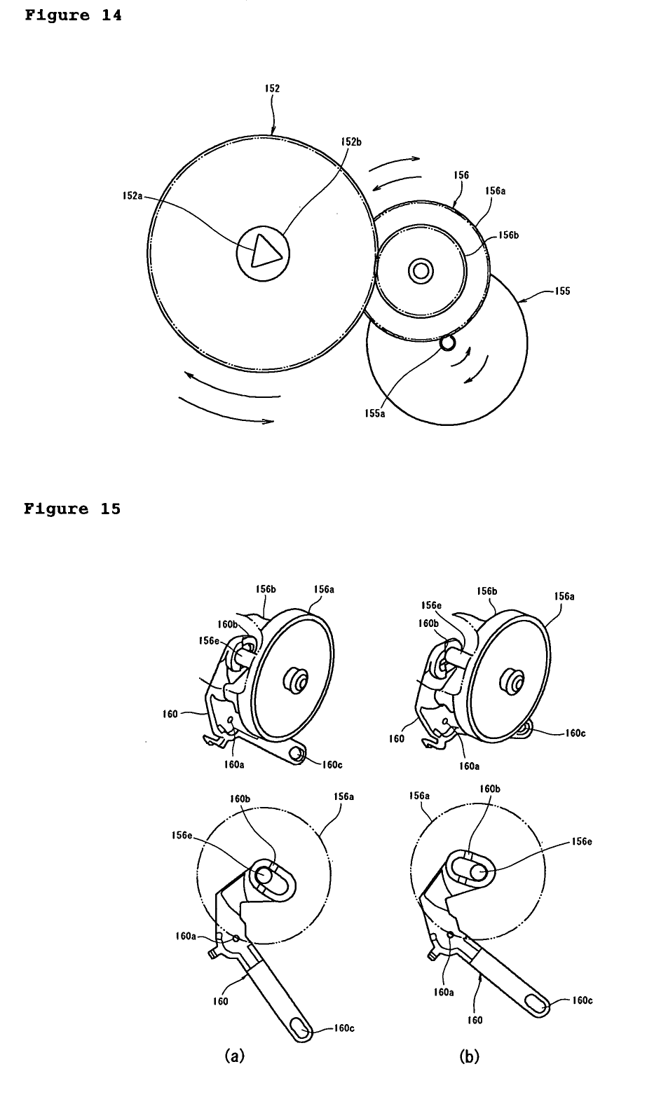

As shown in FIG. 12, the reduction gear 156 is composed of two parts of a reduction input gear 156a and a reduction output gear 156b, and a transmission action of drive between the reduction input gear 156a and the reduction output gear 156b is performed by engagement of two protrusions 156c and two protrusions 156d provided on the respective gears. The reduction gear 156 is rotatably fitted on a fixed shaft 156e supported by the first and second photosensitive drum drive gear supporting members 153 and 154.

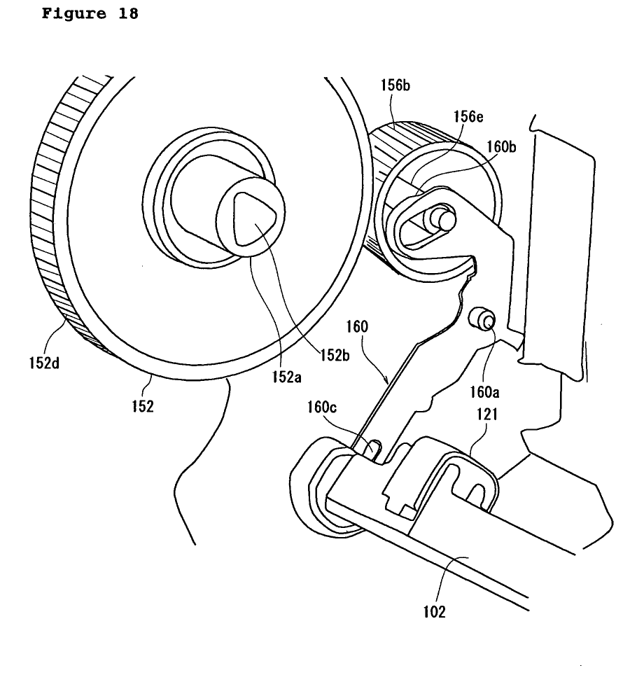

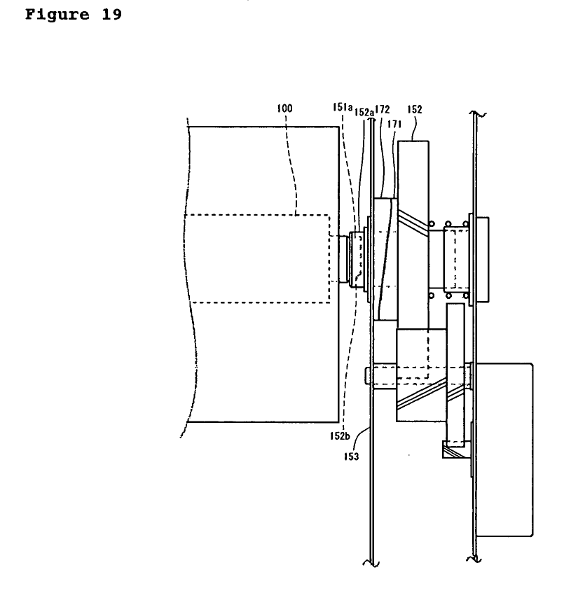

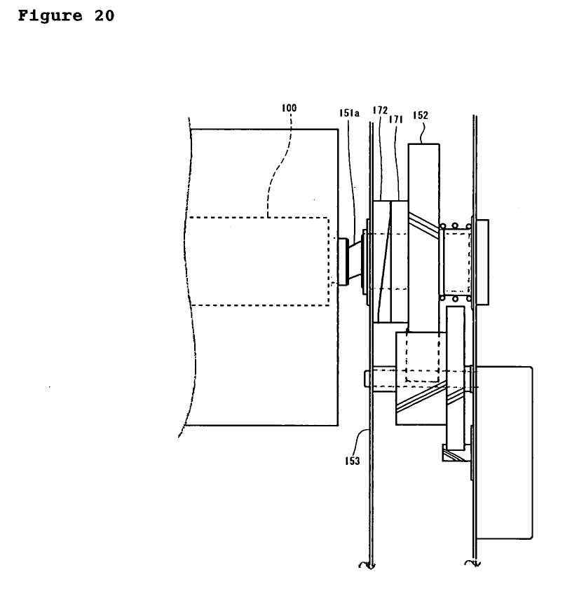

Reference numeral 160 especially shown in FIG. 12 and FIG. 13 denotes a reduction gear retaining member, where the reduction gear retaining member 160 is fitted to the photosensitive drum drive gear supporting member 153 so as to be rotatable about a supporting point 160a through a link mechanism with above-described developing and pressurizing shaft 120. A coupling pin 120a provided at a distal end of the above-described developing and pressurizing shaft 120 is rotatably mounted on a long hole 160c formed at a lower swinging end portion of the reduction gear retaining member 160, so that a link mechanism rotating between a drive position shown in FIG. 17 and a release position shown in FIG. 18 in conjunction with rotation of the developing and pressurizing shaft 120 is constituted.

An inclined cam portion 160b whose thickness gradually changes in the axial direction is formed at an upper swinging end portion of the reduction gear retaining member 160 where the above-described reduction gear retaining member 160 contacts with the reduction output gear 156b, and switching is performed between a state that movement of the reduction output gear 156b in the axial direction is restricted by the reduction gear retaining member 160 and drive transmission is performed through meshing between the projections 156c of the reduction input gear 156a and the projections 156d of the reduction output gear 156b at the drive position (FIG. 17) of the reduction gear retaining member 160 and a state that the reduction output gear 156b is moved in the axial direction to a position where the projections 156c of the reduction input gear 156a and the projections 156d of the reduction output gear 156b do not mesh with each other at the release position (FIG. 18) of the reduction gear retaining member 160. The biasing spring 159 is a compression spring, and it is disposed in a compressed manner such that one end thereof is pressed on the second photosensitive drum drive gear supporting member 154 while the other end thereof is pressed on a side face of the photosensitive drum drive gear 152, so that the photosensitive drum drive gear 152 is always pressed toward the photosensitive drum 100.

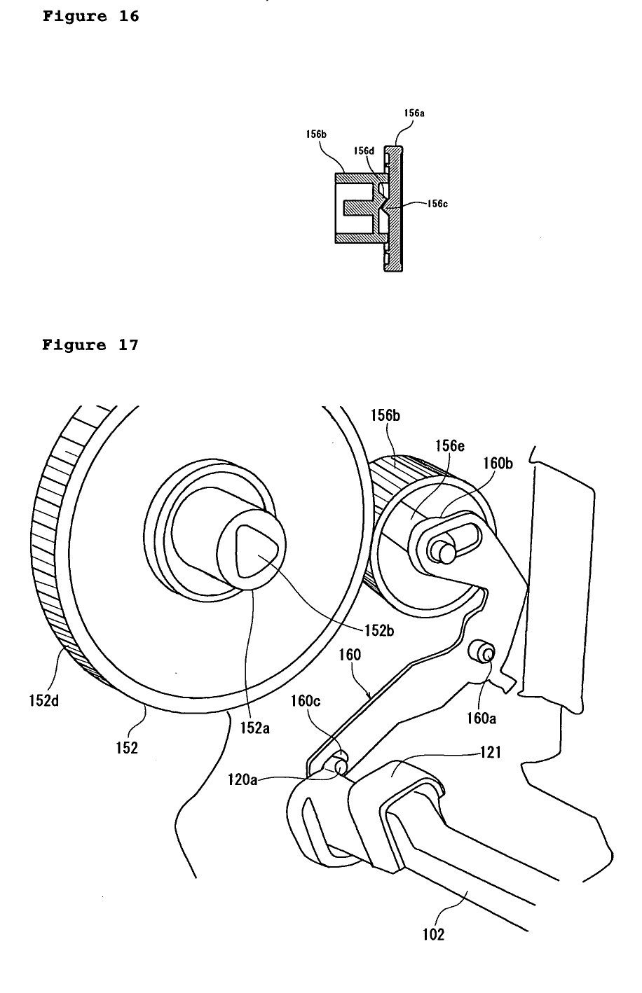

As shown in FIG. 15, when the developing and pressurizing shaft 120 is rotated according to the releasing operation of the above-described releasing lever 6 in the releasing action for disconnecting the drive route from the apparatus main unit 2 to the photosensitive drum 100, the reduction gear retaining member 160 is rotated from the state shown in FIG. 15(a) to the state shown in FIG. 15(b), so that the cam face pressing the reduction output gear 156b is separated from the reduction output gear 156b and the reduction output gear 156b can be moved to a position where the reduction output gear 156b does not mesh with the reduction input gear 156a in the axial direction. Thereafter, when the coupling protrusion portion 151a is caused to be drawn out from the coupling recess portion 152b by drawing out the drum unit 1 in the near side direction, the projection portion and the recess portion are caused to rotate relative to each other, since they are twisted (see the sectional view in FIG. 16).

However, since the stopping load is applied to the coupling protrusion 151a on the side of the photosensitive drum 100, the coupling recess portion 152b on the side of the photosensitive drum drive gear 152 is caused to rotate in a direction reverse to the rotation direction of the photosensitive drum. When the photosensitive drum drive gear 152 is caused to rotate in a reverse direction, the reduction output gear 156b is also caused to rotate in the reverse direction to rotate the reduction input gear 156a in the reverse direction. However, since the stopping load of the pinion portion 155a is large, the reduction output gear 156b is moved in the axial direction to rotate while it is guided by the inclined faces of the two projections of the reduction input gear 156a. Since the engagement of the coupling is released according to reverse rotations of the reduction output gear 156b and the photosensitive drum drive gear 152 to each other without rotationally reversing the reduction input gear 156a and the motor 155 to each other, the reduction output gear 156b serves as a load for moving along the inclined face of the reduction input gear 156a in the axial direction instead of the load of the motor 155, so that taking-out of the drum unit 1 can be performed smoothly owing to reduction of the load (see FIG. 13).

On the other hand, when the above-described releasing lever 6 is rotated back to the original mounting position after the drum unit 1 has been mounted, the reduction gear retaining member 160 is rotated via the developing and pressurizing lever 102 serving as the link mechanism so that the cam face enters between the photosensitive drum drive gear supporting member 153 and the reduction output gear 156b to push out the reduction output gear 156b in a direction of the reduction input gear 156a, which allows transmission of a rotational drive force of the pinion 155a provided on the motor 155 to the photosensitive drum drive gear 152. Thereby, the photosensitive drum drive gear 152 is biased in a direction of approaching to the process cartridge 1 according to action of the biasing spring 159, so that the protrusion portion 151a formed on the end portion of the photosensitive drum 100 and the recessed portion 152b of the photosensitive drum drive gear 152 can be rotated to be engaged with each other.

In the embodiment, therefore, since the drive transmission route to the drum unit 1 is disconnected at a drawing-out time of the drum unit 1 from the apparatus main unit 2 by only performing one operation to the releasing lever 6, facilitation and safety of the drawing-out operation of the drum unit 1 are further improved.

Though the embodiment of the present invention which has been made by the present inventor(s) has been explained above, the present invention is not limited to the embodiments, and it can be modified variously without departing from the gist of the present invention, of course.

For example, the above-described embodiment has described the copier to which the present invention is applied, the present invention can be similarly applied to another image forming apparatus such as a printer.

The above-described image forming apparatus according to the present invention can be widely applied to not only an image forming apparatus such as a copier but also various image forming apparatus such as a printer.

1. An image forming apparatus comprising:
an image bearing member unit which includes an image bearing member for image formation and can be drawn from an apparatus main unit;
a transfer unit which includes a transfer roller for transferring an image formed on the image bearing member to a recording member and is disposed to be capable of separating from the image bearing member unit;
a developing device which includes a developing sleeve for supplying toner on the image bearing member and is disposed to be capable of separating from the image bearing member unit; and
a holding unit which is constituted so as to be capable of holding the image bearing member unit to the apparatus main unit and releasing the image bearing member unit from the apparatus main unit,
wherein the image forming apparatus further comprises a releasing unit which performs a separating operation for separating the transfer unit and the developing device from the image bearing member unit and a releasing operation of the image bearing member unit performed by the holding unit as a single operation when the image bearing member unit is drawn out from the apparatus main unit, and
the releasing unit is constituted to cover a drawing-out unit provided on the image bearing member unit at a mounting time of the image bearing member unit and open the drawing-out unit at a drawing-out time of the image bearing member unit.

2. The image forming apparatus according to claim 1, wherein the releasing unit is link-connected so as to rotate the developing device and the holding unit in synchronism with rotation of the releasing unit, and
the holding unit is link-connected so as to release the transfer unit in synchronism with rotation of the holding unit.

3. The image forming apparatus according to claim 1, wherein the transfer unit is fixed to an opening and closing door portion attached to the apparatus main unit in an openable and closable manner, and
the separating operation of the transfer unit is performed according to an opening operation of the opening and closing door portion.

4. The image forming apparatus according to claim 1 or 2, wherein the releasing unit is constituted to disconnect a drive transmission route from the apparatus main unit to the image bearing member unit at a drawing-out time of the image bearing member unit from the apparatus main unit.

5. The image forming apparatus according to claim 4, wherein the releasing unit is constituted to disconnect the drive transmission route to the image bearing member unit in conjunction with a separating operation of the developing device to the image bearing member unit.
